(19) United States
(12) Patent Application Publication
(10) Pub. No.: US 2007/0159435 A1
(43) Pub. Date: Jul. 12, 2007

(54) CONTROL METHOD, DEVICE AND ELECTRONIC SYSTEM UTILIZING THE SAME

(75) Inventors: Jian-Xun Jiang, Taipei County (TW); Chih-Kuang Lin, Yilan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: TPO DISPLAYS CORP., Miao-Li County (TW)

(21) Appl. No.: 11/620,067

(22) Filed: Jan. 5, 2007

Related U.S. Application Data
(60) Provisional application No. 60/757,207, filed on Jan. 6, 2006.

(51) Int. Cl. G09G 3/36

(52) U.S. Cl. 345/96

(57) ABSTRACT

A control method for a display panel including a plurality of pixel units arranged in a matrix is disclosed. A plurality of video signals are received. A sequence of the video signals and a preset arrangement are compared. When the sequence of the video signals differs from the preset arrangement, polarities are provided to the video signals by a first inversion method for generating a plurality of first data signals. When the sequence of the video signals corresponds to the preset arrangement, polarities are provided to the video signals by a second inversion method for generating a plurality of second data signals. The second data signals are output to the pixel units.

### CROSS REFERENCE TO RELATED APPLICATIONS

This application claims the benefit of U.S. Provisional Application No. 60/757,207.

### BACKGROUND OF THE INVENTION

1. Field of the Invention

The invention relates to a control device and a control method, and more particularly to a control device and a control method for a display panel.

2. Description of the Related Art

Liquid crystal displays (LCDs) are widely used as they possess the favorable advantages of thin profile, light weigh, and low radiation. In order to prevent the LCD from continuously receiving an LCD lift reducing single-polarity bias voltage, a pixel unit respectively receives positive and negative video signals corresponding to odd and even frames.

The conventional inversion methods comprise frame inversion, column inversion, row inversion, and dot inversion.

FIGS. 1a and 1b are schematic diagrams of the frame inversion method. In the frame inversion method, the polarities of the data signals are the same in the same frame but opposite in adjacent frames. If all pixel units receive positive data signals in a frame 10, the pixel units receive negative data signals in an adjacent frame 11.

FIGS. 2a and 2b are schematic diagrams of the column inversion method. In the column inversion method, the same column on the same frame has the same polarity as the data signal but the opposite polarity to its adjacent columns. In a frame 20, the pixel units in odd columns receive positive data signals and the pixel units in even columns receive negative data signals. In an adjacent frame 21, the pixel units in odd columns receive negative data signals and the pixel units in even columns receive positive data signals.

FIGS. 3a and 3b are schematic diagrams of the row inversion method. In the row inversion method, the same row on the same frame has the same polarity data signal but the opposite polarity to an adjacent row. In a frame 30, the pixel units in odd rows receive positive data signals and the pixel units in even rows receive negative data signal. In an adjacent frame 31, the pixel units in odd rows receive negative data signal and the pixel units in even rows receive positive data signals.

FIGS. 4a and 4b are schematic diagrams of the dot inversion method. In the dot inversion method, the polarity of the data signal in the same frame is presented in an interlaced form. In a frame 40, a pixel unit 401 receives positive data signal and pixel units 402˜405 receive negative data signals. In an adjacent frame 41, the pixel unit 401 receives negative data signal and pixel units 402˜405 receive positive data signals.

In a frame, if data signal polarities are repeatedly changed, the flicker effect is less likely to occur. Thus, the flicker effect occurs when the LCD utilizes the frame inversion method, but is less likely to occur when the LCD utilizes the dot inversion method.

FIGS. 5a˜5d show frames of the LCD utilizing the dot inversion method. X represents a data signal received by a pixel unit is equal to zero such that the pixel unit does not display images. As shown in FIGS. 5a and 5b, the polarities of the data signals received by pixel units displaying images are positive in a frame 50 such that the polarities of the data signals received by pixel units displaying images are negative in an adjacent frame 51. Although the LCD utilizes the dot inversion method, the flicker effect may still occur.

Because the number of pixel units receiving the positive data signals exceeds that of pixel units receiving the negative data signals in a frame 52, the number of pixel units receiving the negative data signals exceeds that of pixel units receiving the positive data signals in an adjacent frame 53. Thus, the flicker effect occurs.

### BRIEF SUMMARY OF THE INVENTION

A control method and device for a display panel comprising a plurality of pixel units arranged in a matrix are provided. An exemplary embodiment of a control method for a display panel is described in the following. A plurality of video signals are received. A sequence of the video signals and a preset arrangement are compared. When the sequence of the video signals differs from the preset arrangement, polarities are provided to the video signals by a first inversion method to generate a plurality of first data signals. When the sequence of the video signals corresponds to the preset arrangement, polarities are provided to the video signals by a second inversion method for generating a plurality of second data signals. The second data signals are output to the pixel units.

An exemplary embodiment of a control device for a display panel comprises a register, a processing unit, and a detection unit. The register stores a plurality of video signals. The processing unit provides polarities to the video signals for generating a plurality of data signals. The detection unit compares a sequence of the video signals and a preset sequence and controlling the processing unit according to the result of the detection. When the sequence of the video signals differs from the preset sequence, the processing unit controlled by the detection unit provides the polarities according to a first inversion method. When the sequence of the video signals corresponds to the preset arrangement, the processing unit controlled by the detection unit provides the polarities according to a second inversion method.

Electronic systems are also provided. An exemplary embodiment of an electronic system comprises a plurality of pixel units, a gate driver, and a control device. The pixel units are arranged in a matrix. The gate driver provides a plurality of scan signals to the pixel units. The control device provides a plurality of data signals to the pixel units and comprises a register, a processing unit, and a detection unit. The register stores a plurality of video signals. The processing unit provides polarities to the video signals for generating a plurality of data signals. The detection unit compares a sequence of the video signals and a preset sequence and controlling the processing unit according to the result of the detection. When the sequence of the video signals differs from the preset sequence, the processing unit controlled by the detection unit provides the polarities according to a first inversion method. When the sequence of the video signals corresponds to the preset arrangement, the processing unit controlled by the detection unit provides the polarities according to a second inversion method.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIGS. 1a and 1b are schematic diagrams of the frame inversion method;

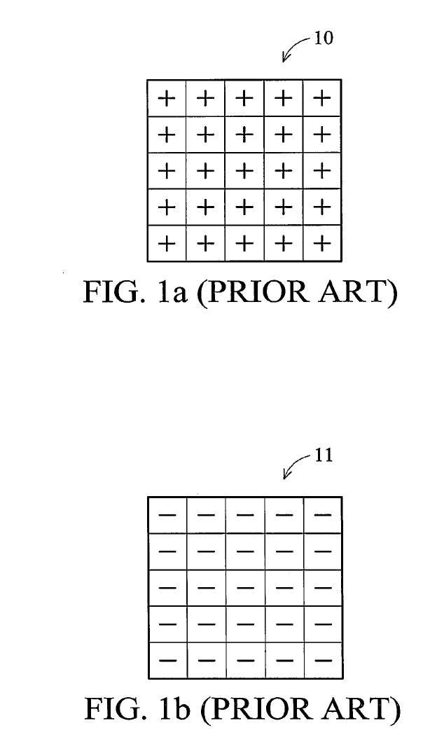

FIGS. 2a and 2b are schematic diagrams of the column inversion method;

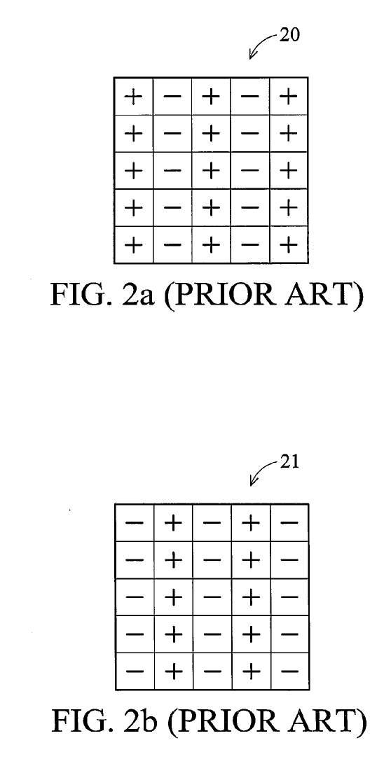

FIGS. 3a and 3b are schematic diagrams of the row inversion method;

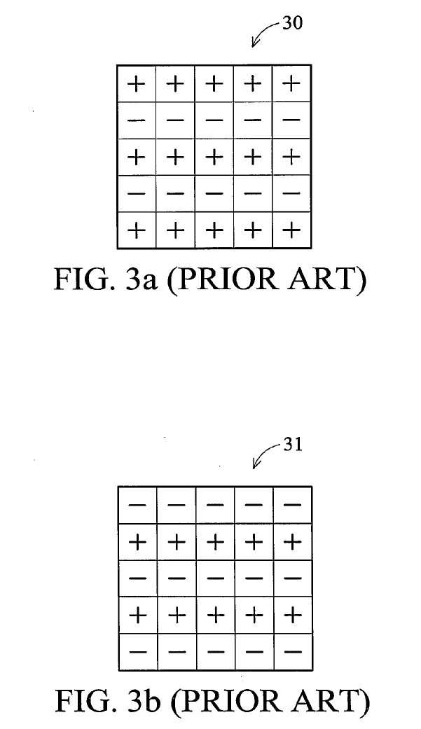

FIGS. 4a and 4b are schematic diagrams of the dot inversion method;

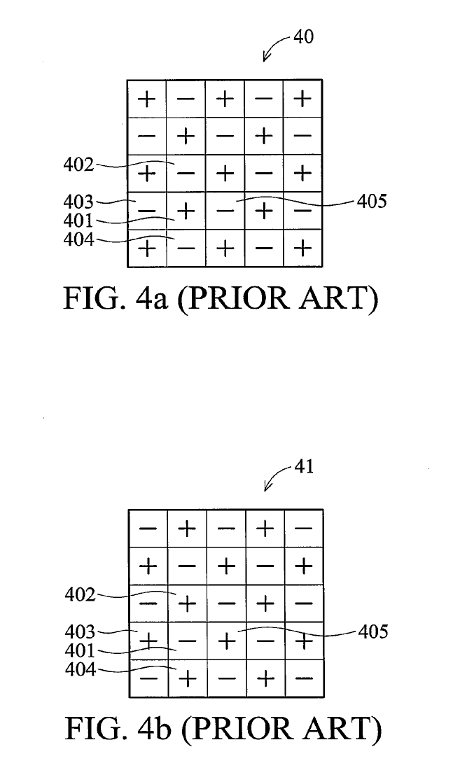

FIGS. 5a˜5d show frames of the LCD utilizing the dot inversion method;

FIG. 6 is a schematic diagram of an exemplary embodiment of an electronic system;

FIG. 7 is a schematic diagram of an exemplary embodiment of a control device;

FIG. 8 is a schematic diagram of an exemplary embodiment of another inversion method; and

FIG. 9 is a flowchart of an exemplary embodiment of a control method.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

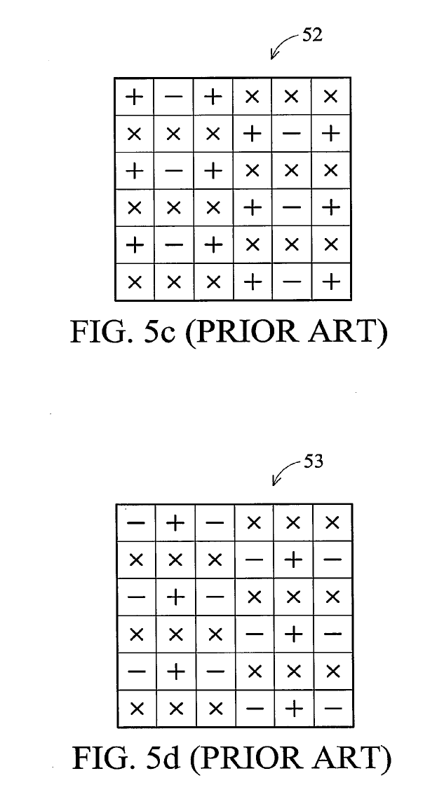

FIG. 6 is a schematic diagram of an exemplary embodiment of an electronic system. The electronic system 60 comprises a display device 61, a gate driver 62, and a control device 63. Display device 61 comprises pixel units 610 arranged in a matrix. Gate driver 62 provides scan signals G1˜Gn to pixel units 610. Control device 63 provides data signals D1˜Dm to pixel units 610 and controls the polarities of the data signals D1˜Dm.

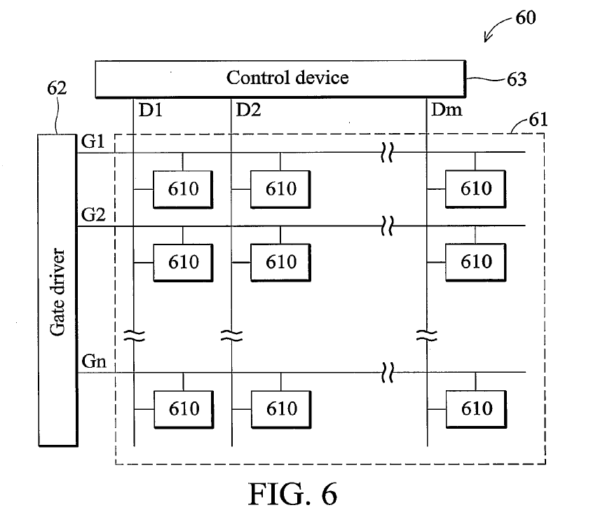

FIG. 7 is a schematic diagram of an exemplary embodiment of a control device. The control device 63 comprises a transformer 70, a processing unit 71, a register 72, and a detection unit 73.

Transformer 70 processes an analog signal VGA to generate video signals I1˜Im. Register 72 stores video signals I1˜Im. Detection unit 73 outputs a control signal Sc to the processing unit 71 according to the stored video signals I1˜Im. In this embodiment, a preset sequence is stored in detection unit 73. The preset sequence represents the sequence of video signals where the flicker effect easily occurs. Detection unit 73 compares the sequence of the stored video signals I1˜Im with the preset sequence and outputs the control signal Sc according to the result of the detection. Processing unit 71 provides polarities to the video signal I1˜Im to generate data signals D1˜Dm according to the control signal Sc.

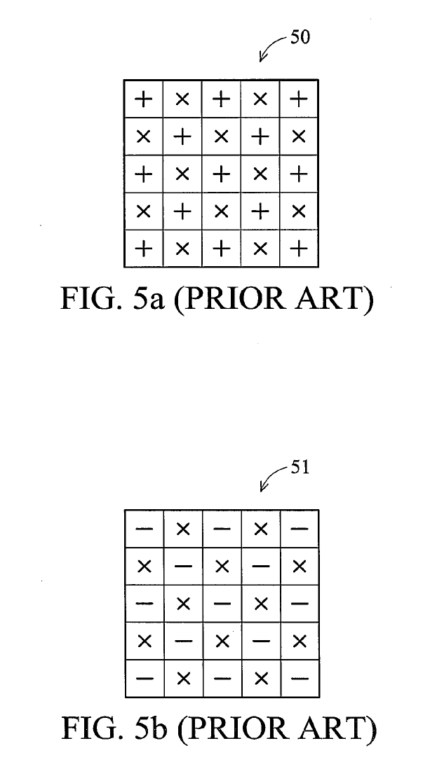

If the sequence of the data signals, which are received by pixel units, corresponds to the sequence shown in FIG. 5a, when frames are switched, the flicker effect will occur. Thus, the sequence shown in FIG. 5a serves as the preset sequence for detecting the sequence of the video signals I1˜Im and determining whether they correspond to the sequence shown in FIG. 5a.

When the sequence of the video signals I1˜Im differs from the preset sequence, detection unit 73 provides the control signal Sc such that processing unit 71 provides polarities to video signals I1˜Im according to a first inversion method. In this embodiment, when processing unit 71 provides polarities to video signals I1˜Im for generating the data signal D1˜Dm according to the first inversion method, the data signal D1˜Dm are referred to as first data signals.

When the sequence of the video signals I1˜Im corresponds to the preset sequence, detection unit 73 provides the control signal Sc such that processing unit 71 provides polarities to video signals I1˜Im according to a second inversion method. In this embodiment, when processing unit 71 provides polarities to video signals I1˜Im for generating the data signal D1˜Dm according to the second inversion method, the data signal D1˜Dm are referred to as second data signals.

Assuming processing unit 71 provides polarities to video signals I1˜Im for generating the data signal D1˜Dm according to a dot inversion method. When the sequence of the video signals I1˜Im corresponds to the preset sequence, processing unit 71 provides polarities to video signals I1˜Im according to other inversion method.

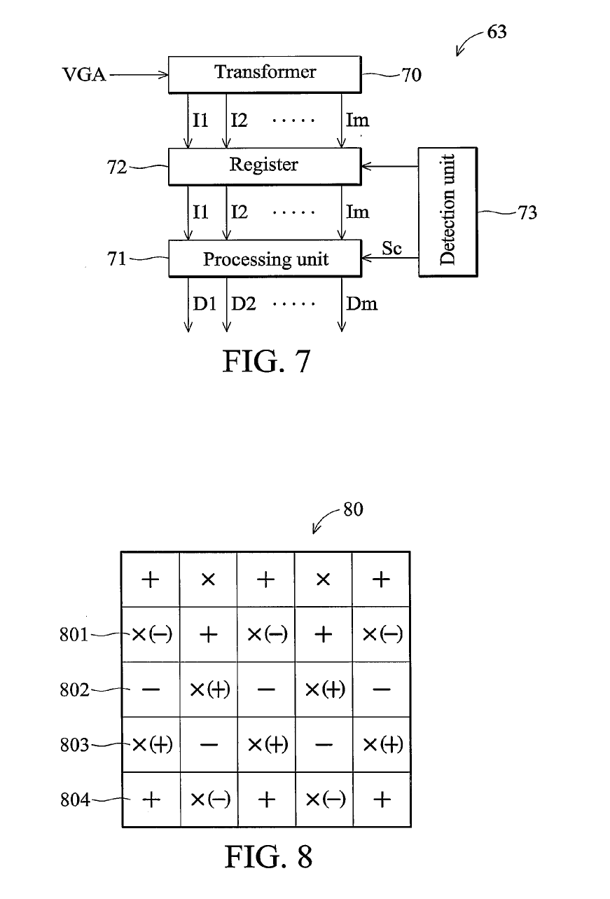

FIG. 8 is a schematic diagram of an exemplary embodiment of another inversion method. When the sequence of the video signals I1˜Im stored in register 72 corresponds to the sequence shown in FIG. 5a, processing unit 71 utilizes the inversion method shown in FIG. 8 to provide polarity to video signals I1˜Im in the adjacent frame.

As shown in FIG. 8, although the inversion method utilized by processing unit 71 is changed from the dot inversion to a second inversion method shown in FIG. 8, the polarities received by pixel units in a first row is maintained, or the polarities in the first row of the frame 80 are equal to a first row of the frame 50. In the frame 80, the polarities received by pixel units in a second row are equal to the polarities received by pixel units in a third row. In the frame 80, the polarities received by pixel units in a fourth row are equal to the polarities received by pixel units in a fifth row.

For example, the polarities of the data signals received by pixel units 801 and 802 are negative and the polarities of the data signals received by pixel units 803 and 804 are positive, wherein pixel units 801 and 803 do not display image. In this embodiment, the polarities received by pixel units in the second row differ with the polarities received by pixel units in the fourth row. In some embodiments, the polarities received by pixel units in the second row are equal to the polarities received by pixel units in the fourth row.

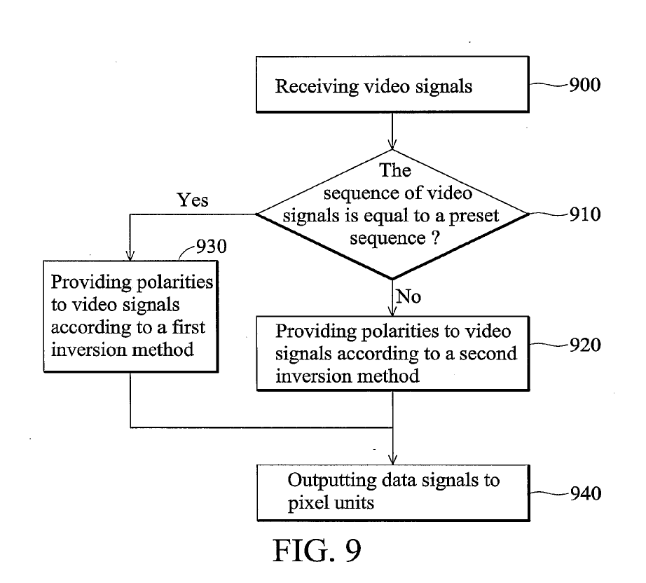

FIG. 9 is a flowchart of an exemplary embodiment of a control method. With reference to FIG. 6, video signals I1˜Im are received (step 900). In this embodiment, register 72 receives and stores video signals I1˜Im output from transformer 70.

The sequence of video signals I1˜Im is detected (step 910). In this embodiment, detection unit 73 compares the stored video signals I1˜Im with a preset sequence.

When the sequence of video signals I1˜Im differs from the preset sequence, polarities are provided to video signals I1˜Im according to a first inversion method (step 920) such that data signals D1˜Dm are generated for the pixel units (step 940).

When the sequence of video signals I1˜Im corresponds to the preset sequence, polarities are provided to video signals I1˜Im according to a second inversion method (step 930) such that data signals D1˜Dm are generated for providing to pixel units (step 940).

Assuming the preset sequence stored in detection unit 73 corresponds to the sequence shown in FIG. 5a and processing unit 71 provides polarities to video signals I1˜Im according to the dot inversion method. If the sequence of video signals I1˜Im stored in register 72 differs from the sequence shown in FIG. 5a, processing unit 71 continuously utilizes the dot inversion method to provide polarities. When the sequence of video signals I1˜Im stored in register 72 corresponds to the sequence shown in FIG. 5a, the inversion method utilized by processing unit 71 switches from the dot inversion method to the inversion method shown in FIG. 8.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control method for a display panel comprising a plurality of pixel units arranged in a matrix, comprising:
receiving a plurality of video signals;
comparing a sequence of the video signals and a preset arrangement;
providing polarities to the video signals by a first inversion method for generating a plurality of first data signals when the sequence of the video signals differs from the preset arrangement;
providing polarities to the video signals by a second inversion method for generating a plurality of second data signals when the sequence of the video signals corresponds to the preset arrangement; and
outputting the second data signals to the pixel units.

2. The control method as claimed in claim 1, wherein the first inversion is a dot inversion method, a row inversion method, or a column inversion method.

3. The control method as claimed in claim 2, wherein the polarity of a first pixel unit in a first row is maintained when the inversion method providing polarities to the video signals switches from the first inversion method to the second inversion method.

4. The control method as claimed in claim 3, wherein the polarity of a second pixel unit in a second row corresponds to that of a third pixel unit in a third row and the polarity of a fourth pixel unit in a fourth row corresponds to that of a fifth pixel unit in a fifth row when the polarities of the video signals are controlled by the second inversion method.

5. The control method as claimed in claim 4, wherein the polarity of the second pixel unit differs from that of the fourth pixel unit.

6. The control method as claimed in claim 4, wherein the polarity of the second pixel unit corresponds to that of the fourth pixel unit.

7. A control device for a display panel comprising a plurality of pixel units arranged in a matrix, comprising:
a register storing a plurality of video signals;
a processing unit providing polarities to the video signals for generating a plurality of data signals; and
a detection unit comparing a sequence of the video signals and a preset sequence and controlling the processing unit according to the result of the detection, wherein the processing unit controlled by the detection unit provides the polarities according to a first inversion method when the sequence of the video signals differs from the preset sequence and the processing unit controlled by the detection unit provides the polarities according to a second inversion method when the sequence of the video signals corresponds to the preset arrangement.

8. The control device as claimed in claim 7, wherein the first inversion is one of a dot inversion method, a row inversion method, and a column inversion method.

9. The control device as claimed in claim 8, wherein the polarity of a first pixel unit in a first row is maintained when the inversion method of the processing unit is changed from the first inversion to the second inversion.

10. The control device as claimed in claim 9, wherein the polarity of a second pixel unit in a second row corresponds to that of a third pixel unit in a third row and the polarity of a fourth pixel unit in a fourth row corresponds to that of a fifth pixel unit in a fifth row when the processing unit utilizes the second inversion method to control polarities of the video signals

11. The control device as claimed in claim 10, wherein the polarity of the second pixel unit differs from that of the fourth pixel unit.

12. The control device as claimed in claim 10, wherein the polarity of the second pixel unit corresponds to that of the fourth pixel unit.

13. The control device as claimed in claim 10, further comprising a transformer generating the video signals to the register according to an analog signal.

14. An electronic system, comprising:
a plurality of pixel units arranged in a matrix;
a gate driver providing a plurality of scan signals to the pixel units; and
a control device providing a plurality of data signals to the pixel units and comprising:
a register storing a plurality of video signals;
a processing unit providing polarities to the video signals for generating the data signals; and
a detection unit comparing a sequence of the video signals and a preset sequence and controlling the processing unit according to the result of the detection, wherein the processing unit controlled by the detection unit provides the polarities according to a first inversion method when the sequence of the video signals differs from the preset sequence and the processing unit controlled by the detection unit provides the polarities according to a second inversion method when the sequence of the video signals corresponds to the preset arrangement.

15. The electronic system as claimed in claim 14, wherein the first inversion is a dot inversion method, a row inversion method, or a column inversion method.

16. The electronic system as claimed in claim 15, wherein the polarity of a first pixel unit in a first row is maintained when the inversion method of the processing unit is changed from the first inversion to the second inversion.

17. The electronic system as claimed in claim 16, wherein the polarity of a second pixel unit in a second row corresponds to that of a third pixel unit in a third row and the polarity of a fourth pixel unit in a fourth row corresponds to that of a fifth pixel unit in a fifth row when the processing unit utilizes the second inversion method to control polarities of the video signals

18. The electronic system as claimed in claim 17, wherein the polarity of the second pixel unit differs from that of the fourth pixel unit.

19. The electronic system as claimed in claim 17, wherein the polarity of the second pixel unit corresponds to that of the fourth pixel unit.

20. The electronic system as claimed in claim 14, wherein the control device further comprises a transformer generating the video signals to the register according to an analog signal.
